(19) United States
(12) Patent Application Publication
(10) Pub. No.: US 2019/0298049 A1
(43) Pub. Date: Oct. 3, 2019

(54) Cosmetic Product Applicator

(71) Applicant: Chanel Parfums Beauté, Neuilly-sur-Seine (FR)

(72) Inventor: Nicolas Castex, Colombes (FR)

(21) Appl. No.: 16/315,885

(22) PCT Filed: Jul. 6, 2017
(86) PCT No.: PCT/FR2017/051842

§ 371 Date: Jan. 7, 2019

(30) Foreign Application Priority Data
Jul. 7, 2016 (FR) 1656557

(51) Int. Cl. A46B 9/02; A46D 3/00; A45D 34/04; B33Y 80/00; B29C 64/153

(52) U.S. Cl. CPC A46B 9/021; A46B 9/028; A46D 3/00; B33Y 50/02; B33Y 80/00; B29C 64/153; A46B 2200/1053; A45D 34/046

(57) ABSTRACT

An applicator for a cosmetic product, including projections each having a base and arranged in at least two groups of projections, wherein the applicator has a longitudinal axis. The bases of projections in the same group form at least one closed loop through which the longitudinal axis of the applicator does not extend.

### FIELD OF THE INVENTION

The invention relates to cosmetic product applicators.

### BACKGROUND OF THE INVENTION

A mascara article, or “mascara”, typically comprises a case, a mascara container and an applicator. There are in particular two types of applicator, bottle brush type and injected type. A bottle brush type applicator forms a brush which comprises bristles formed by fibers trapped in a twisted metal wire forming the core of the applicator. An injected applicator is a single piece and comprises plastic bristles or teeth. Such applicators give the user satisfactory results. However, she is always looking for new or better make-up effects, as well as greater ease of application. Improvements include the search for better separation of the eyelashes, a better elongating and/or curving effect of the eyelashes, or a different make-up effect depending on the location of the eyelash in a row of eyelashes.

### SUMMARY OF THE INVENTION

An object of the invention is therefore to improve the cosmetic product applicators.

The invention therefore relates to a cosmetic product applicator comprising projections each having a base and arranged in at least two groups of projections, the applicator having a longitudinal axis, the bases of the projections in the same group forming at least one closed loop through which the longitudinal axis of the applicator does not extend.

Thus, the presence of groups of projections creates local areas on the applicator which produce a special make-up effect. It is therefore possible to provide different groups of projections arranged along the applicator and each making up differently the eyelashes along a row of eyelashes, thus producing a special make-up effect for the user. The bases of the projections are thus specific to each projection. They are an integral part of the projections. The fact that the bases of projections in the same group of projections form a loop accentuates the make-up effect by area. Since the longitudinal axis of the applicator does not extend through the loop, the projections can be organized locally even more in order to obtain the required make-up effect.

The number of groups of projections may vary. For example, an applicator could comprise between 2 and 50 groups of projections, even between 5 and 40 groups of projections, preferably between 10 and 30 groups of projections. Obviously, an applicator could comprise an even greater number of groups of projections.

In addition, the various groups of projections may be formed by a different number of projections. A group of projections could be composed of 4 to 200 projections, even 15 to 100 projections, for example 30 to 50 projections. All the groups of projections could be composed of the same number of projections.

Within the same group of projections, the projections may all be identical or different regarding their shape, dimension and/or orientation.

Furthermore, since the bases of the projections in a group form a closed loop, this favors the formation of a reserve of make-up product in the centre of the group, especially by capillarity. This reserve is adjacent to the projections which provide the make-up by coming into contact with the eyelashes. It therefore releases this product as soon as the eyelashes come into contact with the group. The eyelashes may even come directly into contact with the product in this reserve.

Advantageously, the projections of at least one of the groups of projections form at least one ring, preferably the projections of each group of projections forming at least one ring.

This conformation offers the advantage of being ordered, compared for example with a tufted conformation, and thus allows better control of the make-up effect obtained with the applicator. The projections are thereby well separated in the ring and thus enable good separation of the eyelashes when applying the mascara. The projections could extend, from the loop formed by their bases, towards the outside of the group, in other words in the direction opposite to the longitudinal axis of the applicator.

Preferably, a main axis of at least one of the groups of projections extends in a plane perpendicular to the longitudinal axis of the applicator.

The main axis of a group of projections corresponds to the axis passing through the centre of the loop. Once again, the projections of the group could extend from the loop towards the outside of the group and thereby facilitate application of the mascara.

Advantageously, the groups of projections form at least two sets, each group of projections having a main axis, the main axes of the groups in the same set extending in the same plane.

Once again, the sets of groups of projections can create special and different make-up effects along the longitudinal axis of the applicator. A set of groups of projections could be composed of 2 to 10 groups of projections, even 3 to 7 groups of projections, preferably 4 to 6 groups of projections. The groups of projections in the same set could be separated one by one by a constant angle relative to the main longitudinal axis of the applicator. The groups of projections in the same set could also be separated one by one by a different angle relative to the longitudinal axis.

Furthermore, the plane comprising the main axes of the groups of projections in the same set could have any orientation relative to the longitudinal axis of the applicator. Preferably, this plane is perpendicular to the longitudinal axis. The planes of the different sets of projections may form different or identical angles between them with the axis. This angle could be between 0° and 90°, even between 20° and 70°, for example between 40° and 60°. The case where all the planes form the same angle with the longitudinal axis is advantageous since it limits the size of the applicator, and even saves space allowing the presence of more sets of groups of projections.

Preferably, the plane comprising the main axes of the groups of projections of one of the sets of groups is parallel to the plane comprising the main axes of the groups of projections of another one of the sets and separate from this plane.

As explained previously, this arrangement limits the size of the applicator and saves space allowing the presence of more sets of groups of projections on the applicator. Preferably, all the planes comprising the main axes of the groups of projections in the same set are parallel to each other.

Preferably, in at least one of the sets, the main axes of at least two of the groups of projections coincide.

A set of groups of projections could comprise several groups whose main axes coincide. For example, a set could comprise at least four groups of projections, these groups being split into two subgroups composed of two groups in which the main axes of the groups coincide.

Advantageously, in at least one of the sets, the main axes of at least two of the groups of projections are perpendicular.

A set of group of projections could comprise several groups whose main axes are perpendicular. For example, the main axes of all the groups in the same set could be perpendicular in pairs.

Preferably, in at least one of the sets, at least two of the groups of projections are the image of each other by a rotation about the longitudinal axis of the applicator, preferably all the groups of projections of the set being the image of each other by this rotation.

This creates an area on the applicator for which, whatever the angle of rotation of the applicator about its longitudinal axis relative to the eyelashes, the same make-up effect is produced for a given position along the applicator. The rotation could be between 20° and 180°, even between 45° and 120°, for example between 70° and 90°.

Advantageously, at least two of the sets are symmetrical to one another relative to a plane.

Thus, the eyelashes arranged along a row of eyelashes will be made up in the same way at two different areas of the row of eyelashes, with an area made up differently in between. This results in a make-up effect “by area” which is particularly pleasant and required by the user. The plane of symmetry could be perpendicular to the longitudinal axis of the applicator.

Preferably, at least one of the sets is the image of itself by a rotation of less than one revolution about the longitudinal axis of the applicator.

As previously, this characteristic allows the eyelashes arranged at a given position along the length of a row of eyelashes to be made up in the same way, regardless of the orientation of the applicator about its longitudinal axis relative to the eyelashes.

Advantageously, at least two of the groups of projections of at least two of the sets are aligned along the longitudinal axis of the applicator.

Thus, all the eyelashes of a row of eyelashes can be made up together or the eyelashes can be made up by area, depending on the required effect, in other words some eyelashes in the row will be made up in one way and other eyelashes in the row will be made up in another way. A group of projections in the same set of groups could also be aligned along the longitudinal axis of the applicator with a group of projections in each set of groups in the applicator.

Preferably, the applicator is arranged so that it does not comprise two respective groups of projections of at least two of the sets which are aligned along the longitudinal axis of the applicator.

This arrangement offers in particular the advantage of reducing the size of the sets of groups of projections on the applicator, thus allowing for example the various sets to be arranged closer to each other.

Advantageously, at least one of the groups of projections is formed by at least one double row of projections whose respective bases form a closed loop.

This double row produces a better make-up result. More especially, it allows better separation of the eyelashes and smoothes the mascara on the eyelashes more efficiently, thus avoiding the formation of “clumps”. Obviously, the closed loop could be formed by the bases of more than one double row of projections, for example by the bases of a triple row, even a quadruple row or a quintuple row.

Preferably, at least one of the groups of projections, preferably each group, has a central opening through the applicator from one side to the other.

This central opening through the applicator from one side to the other, or hole, gives the groups of projections, and the applicator as a whole, greater flexibility. This characteristic thus makes application of the make-up more pleasant for the user. This opening could be covered by a lattice.

Preferably, the central openings of at least two of the groups of projections communicate with each other, preferably the central openings of all the groups of projections communicating with each other.

This improves the flexibility of the applicator and makes application of the make-up more pleasant. In addition, it allows the mascara to flow between these groups and thereby improves the distribution of the product between the groups, thus facilitating the make-up.

Advantageously, the applicator further comprises at least one group of projections of which one main axis coincides with the longitudinal axis of the applicator.

A group of projections is thus positioned at the free end of the applicator. This special position allows the user to perform more precise make-up movements which are useful in particular when she wants to touch up the make-up or make up the small eyelashes at the ends of the eye.

Advantageously, the applicator further comprises at least one support for a group of projections, this support extending from a core of the applicator, preferably each group of projections being supported by such a support.

This characteristic increases the number of groups of projections that the applicator can comprise for a given size of applicator. This support in fact increases the distance between the main axis of the applicator and a group of projections carried by this support, thus creating a space between this group and the central part of the applicator which may therefore comprise a another group of projections. This support may for example consist of a bulge in a core of the applicator.

Preferably, the loops formed by the bases of the projections of at least two separate groups differ by at least one dimension.

This characteristic helps to produce make-up effects which are locally different. The dimensions of the loop which may vary include in particular the largest and the smallest dimensions of the loop.

Preferably, the loops formed by the bases of the projections of at least two separate groups have identical dimensions, preferably all the loops formed by all the groups of projections being identical.

This characteristic is particularly interesting since it creates repetitions, even uniformity of the make-up effect obtained at each group of projections.

Advantageously, at least one of the loops has a generally oblong shape.

Obviously, the loops could have a different general shape, for example circular, parallelepipedic or square. The loops can have different shapes or all have the same shape.

Preferably, at least one of the loops is non-planar.

This characteristic gives the eyelashes a special curve which is a make-up effect required by the user. For example, this loop could be convex, concave or wavy.

Advantageously, at least one of the loop extends around the longitudinal axis of the applicator over a range of between 20° and 350°, preferably extending over a range of between 180° and 300°.

Preferably, at least one of the loops has a generally helical shape.

This special configuration increases the curve of the eyelashes, which is a make-up effect required by the user.

Advantageously, a direction of a larger dimension of at least one of the loops is parallel to the longitudinal axis.

The largest dimensions of all the loops could be parallel to the longitudinal axis.

Preferably, a direction of a larger dimension of at least one of the loops is inclined relative to the longitudinal axis by an angle of between 5° and 90°.

This inclination could be equal for all the loops. All the loops could also have different inclinations.

Advantageously, the applicator comprises a hollow core.

This characteristic creates a lighter applicator, which simplifies make-up. In addition, this improves the flexibility of the applicator and makes application of the make-up more pleasant for the user. The hollow core is formed by a wall. This wall could have the same thickness over its entire length. This wall could also be solid or perforated. In the latter case, the wall could form a more or less dense lattice or mesh. The perforated aspect makes the applicator more flexible and therefore application of the make-up more pleasant for the user.

Advantageously, the applicator is arranged so that, seen from one end, no space is left free by the projections over the entire circumference of a core of the applicator.

Thus, regardless of the degree of rotation of the applicator about its axis, there is a region of the row of eyelashes which is made up by the applicator.

Preferably, the applicator comprises a core having more than ten holes extending out of the loops.

As explained previously, this characteristic helps to make the applicator more flexible and therefore application of the make-up more pleasant for the user. The core could be formed by a mesh or lattice or have an exoskeletal structure.

The invention further provides for a cosmetic article comprising an applicator as described previously.

The invention also provides for a method of manufacturing by additive synthesis an applicator as described previously, comprising the following steps:
obtaining data concerning the applicator; and
additive synthesis of the applicator using the data.

The advantage of this type of manufacture is, in particular, that it can be used to produce applicators of complex structure, which it would be difficult or even impossible to produce by injection, considering in particular the existence of some parts with undercut.

Various additive synthesis methods known by those skilled in the art can be used to manufacture the invention. They include, for example, selective laser sintering (SLS) and stereolithography (SLA). An example of a method of manufacturing a cosmetic product applicator by additive synthesis is described in application WO 2008/113939 in the name of the applicant.

The invention also provides for an electronic storage medium comprising stored data to implement the method as described previously.

The invention further provides for a computer file comprising data that can be used by a computer program to control the implementation of the method as described previously.

Lastly, the invention also provides for a method of placing on a telecommunications network a computer file comprising data suitable for use by a computer program for controlling the implementation of the method as described previously in order to download it.

### BRIEF DESCRIPTION OF THE DRAWINGS

We will now describe several embodiments of the invention given as non-limiting examples in reference to the drawings, in which:

FIG. 1 is a diagrammatic longitudinal cross-section of a cosmetic article according to one embodiment of the invention;

FIGS. 2A to 2C are views respectively from the free end and from the side according to two different degrees of rotation of an embodiment of the applicator of FIG. 1;

FIG. 2D is a longitudinal cross-section along the plane D-D of the applicator of FIGS. 2A to 2C;

FIGS. 3A to 3C are respectively a side view, a longitudinal cross-section and a view from the free end of a second embodiment of the applicator of FIG. 1;

FIG. 4 is a view from the free end of a third embodiment of the applicator of FIG. 1;

FIGS. 5A to 5C are side and perspective views of a fourth embodiment of the applicator of FIG. 1 showing different degrees of rotation about its longitudinal axis;

FIG. 5D is a cross-section of the applicator of FIGS. 5A to 5C; and

FIG. 5E is a view, from its free end, of the applicator shown on FIGS. 5A to 5D.

### DETAILED DESCRIPTION OF THE INVENTION

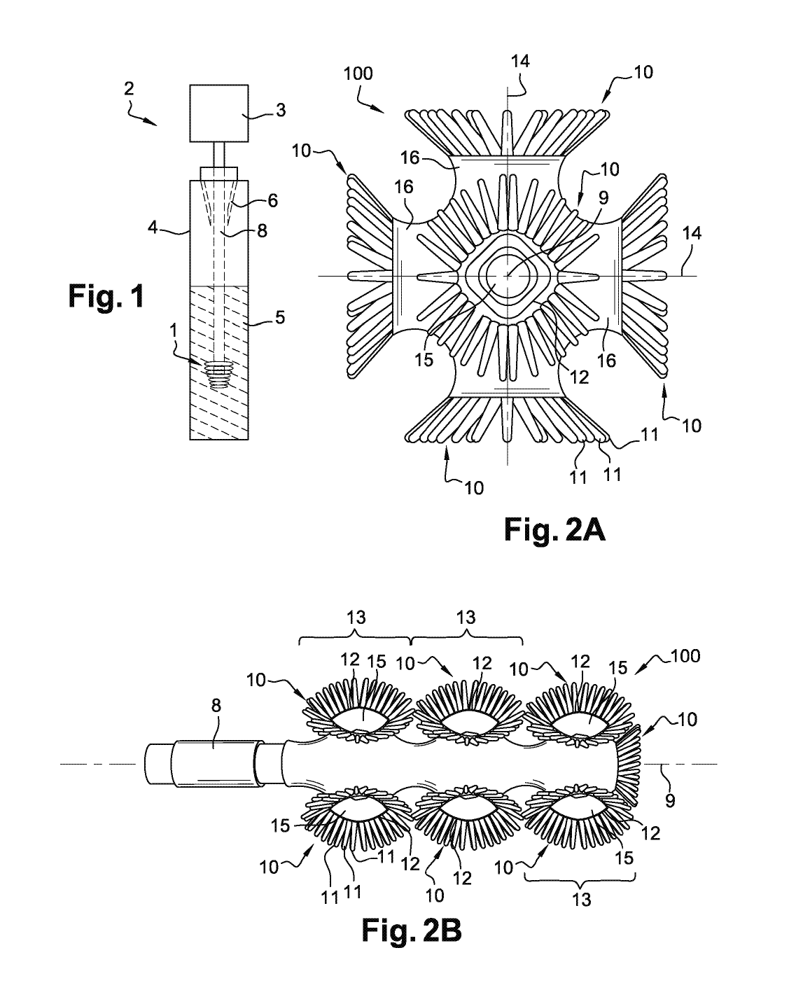

We will now describe four embodiments of the applicator and of the method according to the invention, in reference to FIGS. 1 to 5E. We will describe here mascara applicators but, obviously, the applicator according to invention could be used with another cosmetic product, for example nail varnish, lipstick or gloss.

The mascara applicator 1 described in this embodiment is part of a cosmetic article 2 comprising a cap or plug 3, to which the applicator 1 is rigidly attached, and a case 4 comprising a mascara container 5 and a wiper 6 (see FIG. 1) housed in the collar of the container on which the cap can be removably attached, for example screwed, to close the container of the article. The applicator thus extends in the container and is immersed in the mascara.

Obviously, other types of article with mascara applicators can be considered such as for example “pen” type articles in which the applicator is not connected to a cap or articles in which the applicator is not immersed in the mascara reserve when not used.

The applicator is carried by a straight rod 8 which connects it to the cap 3. The applicator has an elongate general shape along its longitudinal axis 9. The rod 8 has a generally straight cylindrical shape. The rod and the applicator are connected together by one of their ends.

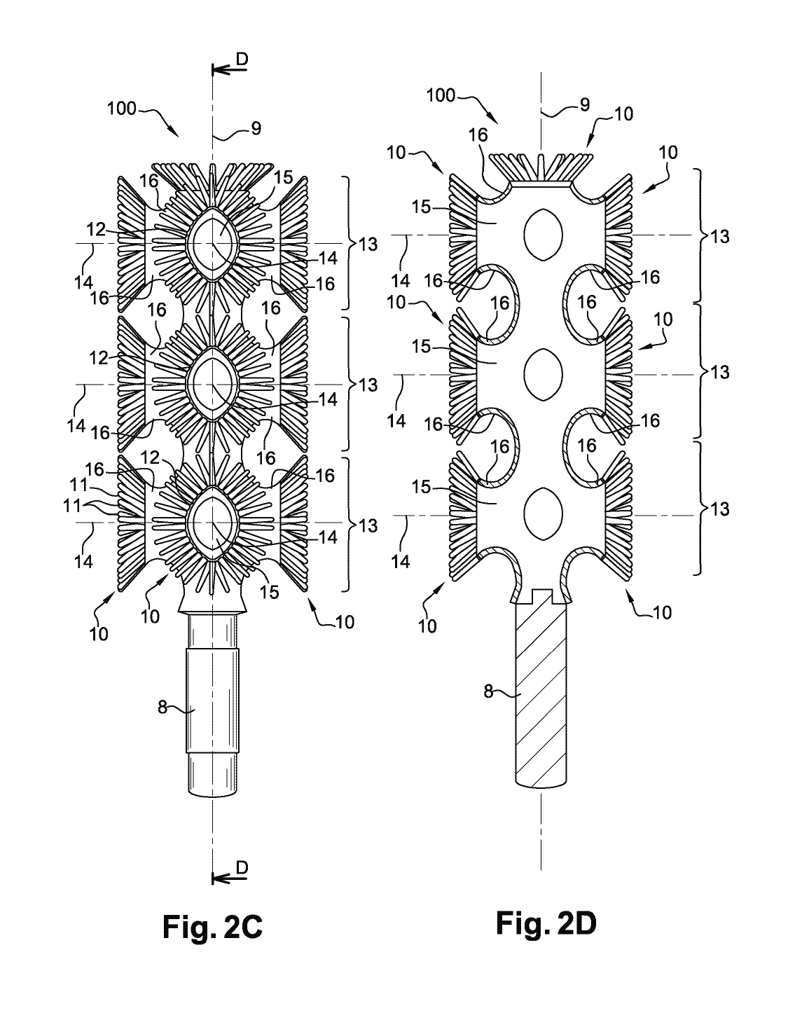

### First embodiment: FIGS. 2A to 2D

The Applicator

The applicator 100 described in this embodiment comprises thirteen groups 10 of projections 11. Each group of projections comprises the same number of projections 11, namely thirty in this case. Obviously, the groups 10 of projections could comprise different numbers of projections 11.

In this embodiment, the groups 10 form three sets 13 of groups. Each set 13 is composed of four groups 10 of projections. Obviously, the applicator could comprise a greater or smaller number of sets 13 and these sets could be composed of a greater or smaller number of groups 10 of projections. The sets 13 could also not all be composed of the same number of groups 10. The groups 10 of the various sets 13 are aligned along the longitudinal axis 9 of the applicator. Obviously, the groups of the various sets could be offset relative to each other along the longitudinal axis 9 of the applicator. The groups thus form four rectilinear rows of groups, the rows being parallel to the axis 9. They also form three circular rows in planes perpendicular to the axis, which form the sets.

Within the same set 13, the groups 10 are the images of each other by a 90° rotation about the longitudinal axis of the applicator. Obviously, this rotation could be greater or smaller, for example greater than 100° or less than 80°, even greater than 120° or less than 60°, or even greater than 150° or less than 40°. In addition, none of the groups 10 of projections in the same set 13 could be the image by rotation of another group 10 in the same set.

The main axes 14 of the groups 10 of projections in the same set 13 are all located in the same plane (see FIG. 2A). The groups 10 in the same set 13 are separated by an angle of 90° relative to the longitudinal axis 9 of the applicator. Thus, the main axes 14 of two groups located on either side of the applicator coincide. The main axes of two groups 10, which follow each other directly on turning around the longitudinal axis of the applicator are perpendicular.

The three planes containing the main axes 14 of the groups 10 of the three sets 13 of the applicator are parallel to each other (see FIG. 2C). Obviously, only some of these planes could be parallel to each other.

In the present case, these planes are perpendicular to the axis 9 of the applicator. Obviously none of the planes, or only some of them, could be perpendicular to this axis.

There is a plane of symmetry between the sets 13 of the applicator. In the present case, there is a plane of symmetry between each pair of consecutive sets along the axis of the applicator. There could be a plane of symmetry between only some of the sets 13 of the applicator 100.

The bases of the projections 11 in the same group form a closed loop 12. Each projection comprises its own base. The bases are therefore included in the projections. In other words, each base of each projection is independent of the other bases of the other projections. Apart from the group 10 located at the free end of the applicator 100, the longitudinal axis 9 of the applicator does not extend through the loop 12 of the groups. The main axis of the group located at the free end of the applicator coincides with the longitudinal axis of the applicator.

The loops, other than the loop of the group 10 located at the free end of the applicator, are all identical. They have a generally oblong shape (see FIG. 2C) and each one extends in a plane parallel to the axis 9. The loop 12 of the group 10 located at the free end has a diamond shape (see FIG. 2A). Obviously, the loops could have different shapes. All the loops could also be different from each other.

The direction of the largest dimension of the loops 12 is parallel to the longitudinal axis 9 (see FIG. 2C). Obviously, this does not have to be the case and this direction could be inclined at an angle of between 5° and 90°, for example between 15° and 80°, or between 30° and 60°, or even between 40° and 50°.

The loop 12 of any group 10, except the end group, defines a central opening 15 through the applicator from one side to the other. In the present case, each group has a central opening 15 through the applicator from one side to the other up to the opening of the diametrically opposed group. Obviously, only a few groups could have a central opening 15 through the applicator from one side to the other. Also, none of the groups could have such an opening.

In a particular embodiment, at least some of the central openings 15 of the groups, even all the central openings 15, could be partly blocked by a mesh or lattice.

In the present case, the applicator comprises a hollow core so that all the central openings 15 of the applicator communicate with each other, in particular along the axis 9. Obviously, these central openings 15 do not all have to communicate with each other.

The walls of the core are solid, but this does not have to be the case. For example, a wall could be perforated, thereby forming a mesh or lattice or an exoskeletal structure.

The projections 11 of a group 10 of projections are all identical. They are rectilinear, elongate and their thickness decreases substantially from their base to their tip. They extend from the loop 12 defined by their base towards the outside, in other words in a direction extending away from the longitudinal axis 9 of the applicator 100. They are arranged in an ordered row going around the loop 12 and thus form a ring. In the present case, all the groups 10 of projections 11 of the applicator 100 form a ring. This arrangement could also be designated as a flower or corolla configuration. Taken all together, the projections of a group have a flared envelope surface.

There are several planes of symmetry within the same group 10 of projections 11. There is in particular a plane of symmetry containing the direction of the largest dimension of the loop 12 and another plane containing the direction of the smallest dimension of the loop 12. The projections could have a different shape, for example curved or wavy, even conical and/or hollow.

The groups of projections are carried by a support 16. This support 16 is formed by a bulge in the core of the applicator. In the present case, each group 10 of projections is carried by such a support 16. Obviously, none, or only some, of the groups could be carried by a support 16. The supports do not necessarily have to be separate from the core of the applicator.

Using the Applicator

Initially, the user handles the applicator 100, holding the cap 3 between her fingers and inserts the applicator 100 into the mascara container 5 of the article 2. During this step, the projections 11 are loaded with mascara.

When the applicator is removed from the container, it passes through the wiper 6 and the projections 11 are thus wiped so as to leave only the amount necessary for the make-up on them and thereby avoid the formation of “clumps”. Mascara is also present on the body of the applicator between the various groups in their centers.

During use, the user brings the applicator up to her eyelashes in order to apply the make-up, using a traditional make-up movement, mostly vertical. The mascara present on the projections 11 is thus deposited on the eyelashes. In the same movement, these projections smooth the mascara deposited and comb the eyelashes. In the present case, for a row of eyelashes there are three make-up areas along the applicator 100 which correspond to the three groups 10 aligned along the longitudinal axis 9 of the applicator which produce a make-up effect by area.

In addition, the fact that the core is hollow gives the applicator a certain degree of flexibility making application of the mascara more pleasant for the user.

The group of projections located at the free end of the applicator allows more precise make-up of the eyelashes, for example on a small area, and is thus particularly useful to touch up the make-up.

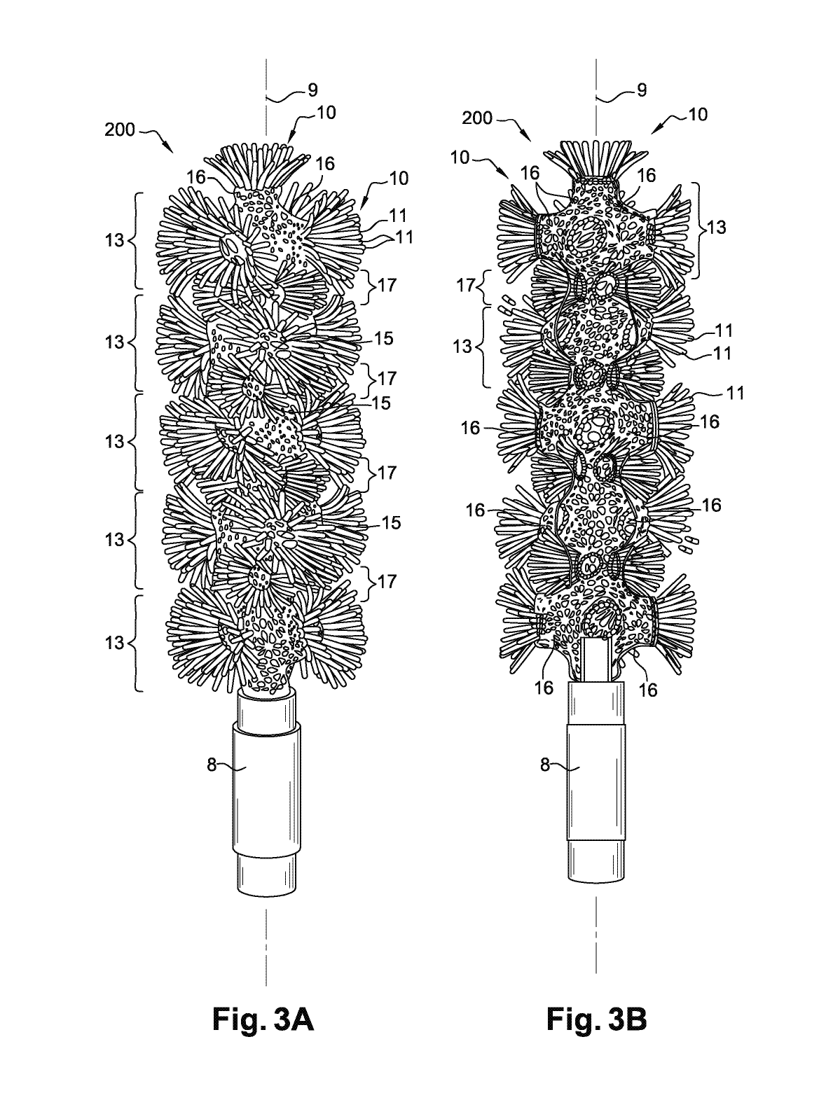

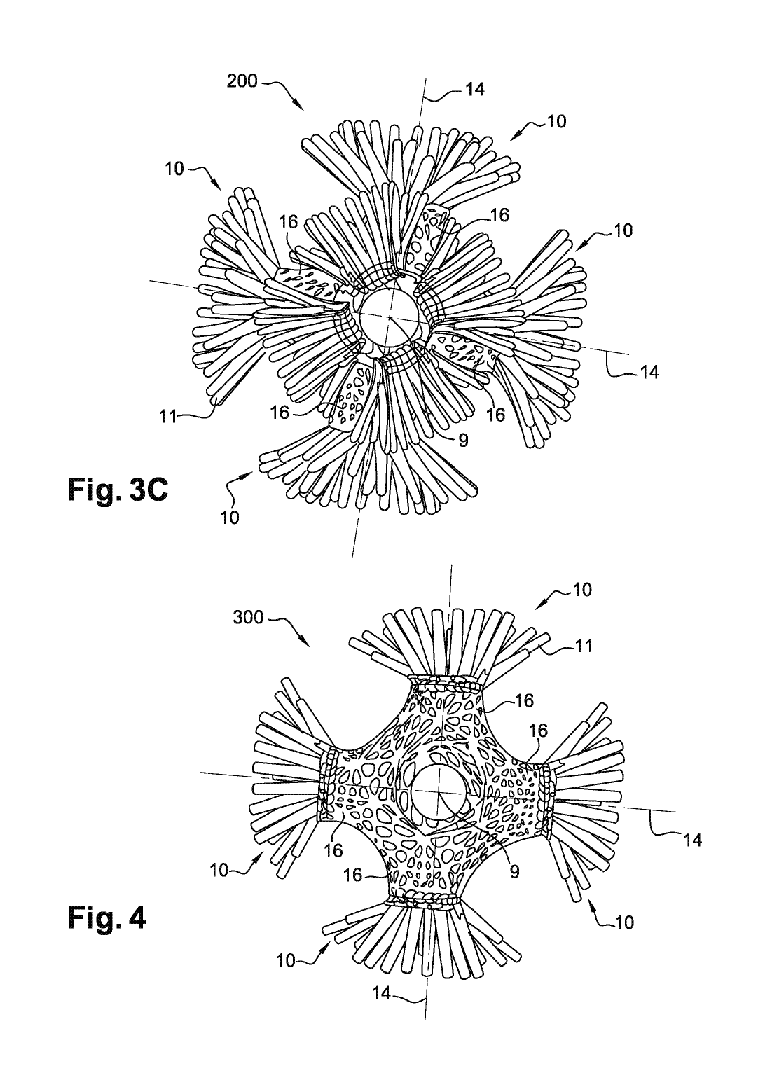

### Second Embodiment: FIGS. 3A to 3C

We will now describe a second embodiment of the applicator according to the invention, which can be used in the article of FIG. 200.

The applicator of this embodiment differs from the applicator of the first embodiment in various respects. We will only describe the differences between this embodiment and the previous one.

Firstly, the core of this applicator 200 is perforated between the groups. This characteristic makes the applicator more flexible and therefore application of the make-up more pleasant for the user. In the present case, the core comprises a large number of holes. This number is greater than one hundred, for example greater than two hundred, or even greater than three hundred. This large number of holes gives the core a mesh or lattice structure, even an exoskeletal type structure. The holes may have different sizes and shapes. Most have generally irregular substantially circular or oblong shapes. Obviously, other shapes are possible, for example generally polygonal shapes.

In this embodiment, the applicator 200 comprises thirty-seven groups 10 of projections 11. These groups are distributed into nine sets composed of four groups 10 each, as well as a group located at the free end.

There are two types of sets, namely sets 13 of a first type in which the groups 10 are carried by supports 16 and sets 17 of a second type in which the groups 10 are not carried by supports 16 (see FIGS. 3A to 3C). In the present case, the applicator comprises five sets 13 of the first type and four sets 17 of the second type. The loops 12 and the projections 11 of the groups 10 of these sets 17 are smaller than those of the other sets 13.

These types of sets 13, 17 alternate when moving along the applicator from its proximal end towards its free end. This characteristic allows the applicator to comprise a greater number of sets 13, 17 and to have a higher density of projections.

In addition, these types of sets are staggered with reference to their angular position about the axis, in other words when viewing the applicator from one end. Thus, the groups associated with the first type are not aligned with those of the second type parallel to the axis and even extend between two groups of the second type.

Obviously, there could be a different number of sets 13, 17 and/or the sets could be composed of a different number of groups 10 of projections 11.

Another difference compared with the first embodiment lies in the fact that the groups of projections are composed of a double row of projections 11. This characteristic also increases the density of projections 11 of the applicator 1. The groups 10 could be composed of more than two rows of projections, for example three, four or five. The various rows of projections 11 of the same group 10 could be composed of the same number of projections. The number of projections in the various rows could also be different.

The loops 12 of the various groups 10 of this applicator each define central openings 15 which are partly blocked and form a mesh or lattice or an exoskeletal structure similar to that of the core of the applicator. The central openings 15 of all the groups 10 of projections communicate with each other. This applicator comprises groups with loops 12 which may be oblong or circular with larger or smaller dimensions which may vary between the various loops.

When looking at the applicator from its free end, the entire periphery of the applicator is occupied by projections 11 of the groups 10 of the various sets 13, 17. As seen previously, the groups 10 of projections of two consecutive sets along the applicator are offset angularly around the longitudinal axis 9 of the applicator.

The use of this applicator is similar to that of the applicator of the first embodiment except that there are more make-up areas and that different make-up effects are obtained depending on whether or not the group 10 of projections making up the eyelash is carried by a support 16. This latter characteristic can be used for example to curve the eyelashes differently and give the row of eyelashes a wave which is a make-up effect particularly required by the user.

### Third Embodiment: FIG. 4

This embodiment differs from the second embodiment only by the fact that the applicator 300 does not comprise sets 17 of the second type, in other words whose groups 10 are not carried by supports 16 (see FIG. 4). The density of groups and projections is therefore reduced.

The use of this applicator is similar to that described for the first two embodiments.

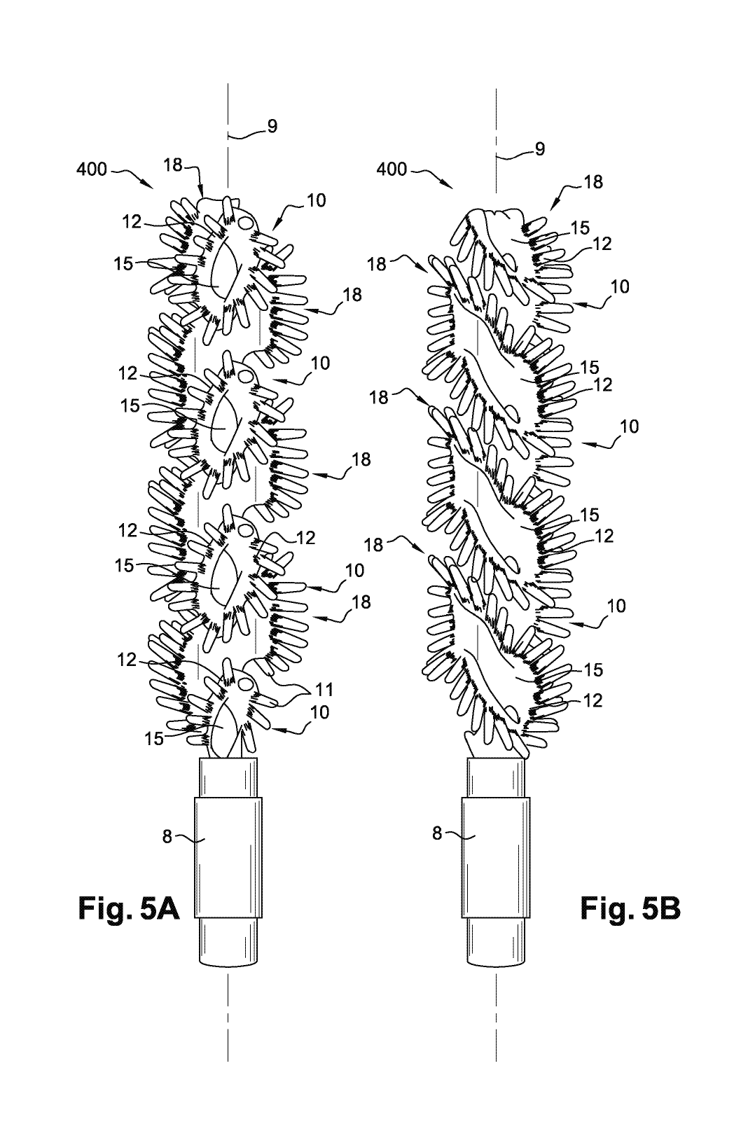

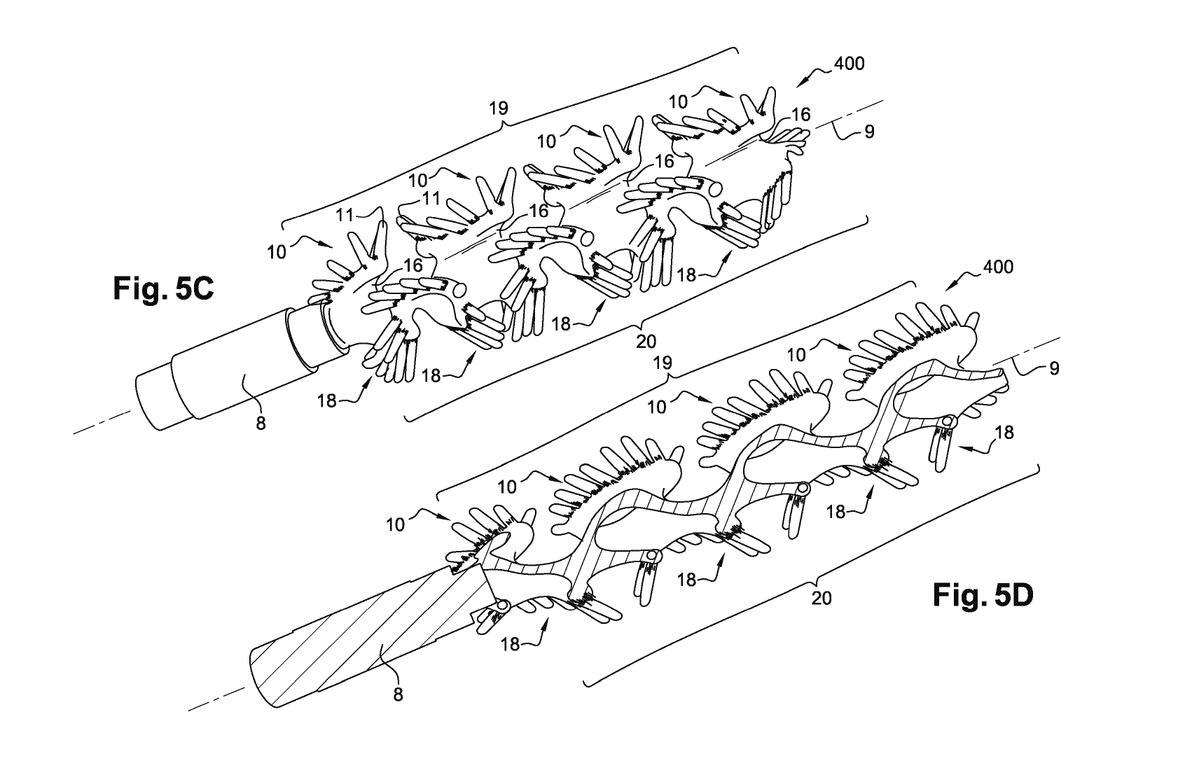

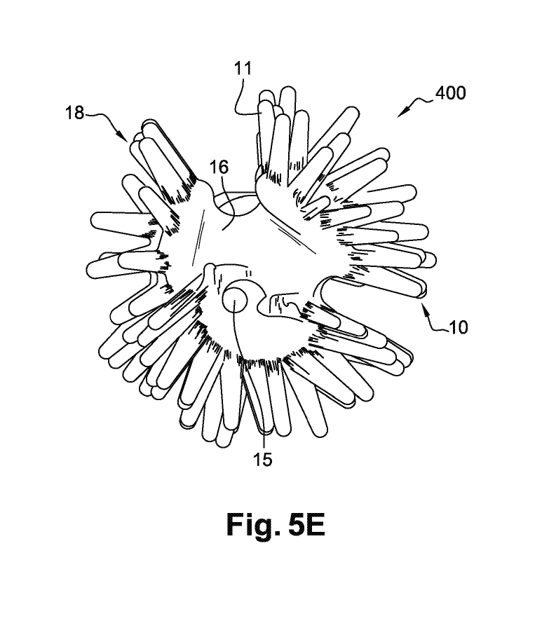

### Fourth Embodiment: FIGS. 5A to 5E

The applicator 400 of this embodiment differs from the applicator of the first embodiment in various respects.

Referring to FIGS. 5A to 5E, this applicator comprises two main types of groups 10, 18 of projections 11.

A first type of groups 10 of projections is similar to those described in the first embodiment. The groups 10 of projections of this type are carried by a support 16 (see FIG. 5C).

The second type of groups 18 of projections is particular in that the loop 12 formed by the projections is more elongate and winds partly around the longitudinal axis 9 of the applicator. This winding winds the group 10 of projections 11 around this axis. The winding range of a group 18 around the axis of the applicator extends over 180° in the present case. This range could be between 20° and 350°, preferably between 180° and 300°. These groups 18 have a generally helical shape.

The groups 10, 18 of projections of the same type are all identical to each other and are aligned along the longitudinal axis 9 of the applicator.

The loops 12 of all the groups 10, 18 are non-planar. Obviously, this does not have to be the case for the groups other than those which wind around the longitudinal axis 9 of the applicator.

In the present case, the applicator comprises four groups 18 of projections of the second type (winding around the longitudinal axis 9) and four groups 10 of projections of the first type. In the embodiment described on FIGS. 5A to 5E, the most distal group 18 of projections is truncated such that its loop is not closed.

In this embodiment, the applicator comprises two sets 19, 20 of groups 10, 18 of projections. In these sets 19, 20, the groups 10, 18 are aligned along the longitudinal axis 9. The main axes of the groups of these two sets are contained in the same plane, this plane also containing the longitudinal axis 9. Obviously, there could be a greater number of sets. These sets could also be composed of a larger or smaller number of groups.

The loops 12 defined by the groups 10, 18 of projections all define a central through-opening 15. All the openings 15 communicate with each other.

The largest dimension of the loops of the various groups of projections is inclined relative to the longitudinal axis of the applicator. This inclination is between 5° and 90°, for example between 15° and 80°, even between 30° and 60°, or even between 40° and 50°. Obviously, the largest dimension of these loops 12 could be parallel to this axis.

The Manufacturing Method

The applicators described above are manufactured in one piece. More particularly, these applicators are manufactured in this case by additive synthesis, also known as 3D printing.

Any suitable material can be used to manufacture these applicators. It may be a plastic, for example a polyamide, in particular a polyamide 1102, a PEBA 2301, or an ABS type resin, or a powdered metal such as a stainless steel or titanium.

The material may be rigid but will preferably be elastically flexible. Preferably, the material, in combination with the applicator's shape characteristics, gives the applicator a certain degree of flexibility.

Note that the length of a mascara applicator is generally less than 20 mm.

Several additive synthesis methods may be used to manufacture an applicator as described previously. We may mention in particular selective laser sintering from powdered material, and stereolithography (SLA). In the present case, a selective laser sintering method is used, this method offering the advantage of allowing objects of complex shape to be manufactured.

The applicator is first designed using computer-aided design (CAD) software. A file in STL format with the applicator design data is therefore created and then exported. These data determine the shape of the applicator. Other standard file formats for additive synthesis may be used.

This file is then processed by software supplied by the manufacturer of the machine used to carry out the additive synthesis. This software breaks down the file into sections in the form of about hundred digital images in SLI or BFF format, each image corresponding to a layer of the model to be printed, i.e. to a section of the applicator taken in a plane perpendicular to the longitudinal axis of the applicator 9. These data are then sent to the printer to produce the applicator.

Once the synthesis is finished, treatments may be applied to the applicator, for example to improve its appearance.

Obviously, numerous modifications can be made without leaving the scope of the invention.

The embodiments described above concern mascara applicators and eyeliners, but these characteristics can be applied to other types of cosmetic product applicator such as applicators of nail polish, lipstick or cosmetic product for the eyebrows or the hair.

1. A Cosmetic product applicator comprising projections each having a base and arranged in at least two groups of projections, the applicator having a longitudinal axis, the bases of the projections in the same group forming at least one closed loop through which the longitudinal axis of the applicator does not extend.

2. The applicator according to claim 1, wherein the projections of at least one of the groups of projections form at least one ring.

3. The applicator according to claim 1, wherein a main axis of at least one of the groups of projections extends in a plane perpendicular to the longitudinal axis of the applicator.

4. The applicator according to claim 1, wherein the groups of projections form at least two sets, each group of projections having a main axis, the main axes of the groups in the same set extending in one plane.

5. The applicator according to claim 4, wherein the one plane comprising the main axes of the groups of projections of one of the sets is parallel to another plane comprising the main axes of the groups of projections of another one of the sets and separate from the one plane.

6. The applicator according to claim 4, wherein, in at least one of the sets, the main axes of at least two of the groups of projections coincide.

7. The applicator according to claim 4, wherein, in at least one of the sets, the main axes of at least two of the groups of projections are perpendicular.

8. The applicator according to claim 4, wherein, in at least one of the sets, at least two of the groups of projections are an image of each other by a rotation about the longitudinal axis of the applicator.

9. The applicator according to claim 4, wherein at least two of the sets are symmetrical to one another relative to a plane.

10. The applicator according to claim 4, wherein at least one of the sets is an image of itself by a rotation of less than one revolution about the longitudinal axis of the applicator.

11. The applicator according to claim 4, wherein at least two of the groups of projections of at least two of the sets are aligned along the longitudinal axis of the applicator.

12. The applicator according to claim 4, arranged so that it does not comprise two respective groups of projections of at least two of the sets which are aligned along the longitudinal axis of the applicator.

13. The applicator according to claim 1, wherein at least one of the groups of projections is formed by at least one double row of projections whose respective bases form a closed loop.

14. The applicator according to claim 1, wherein at least one of the groups of projections has a central opening through the applicator from one side to the other.

15. The applicator according to claim 14, wherein the central openings of at least two of the groups of projections communicate with each other.

16. The applicator according to claim 1, which further comprises at least one group of projections of which one main axis coincides with the longitudinal axis of the applicator.

17. The applicator according to claim 1, which further comprises at least one support for a group of projections, this support extending from a core of the applicator.

18. The applicator according to claim 1, wherein the loops formed by the bases of the projections of at least two separate groups differ by at least one dimension.

19. The applicator according to claim 1, wherein the loops formed by the bases of the projections of at least two separate groups have identical dimensions.

20. The applicator according to claim 1, wherein at least one of the loops has a generally oblong shape.

21. The applicator according to claim 1, wherein at least one of the loops is non-planar.

22. The applicator according to claim 1, wherein at least one of the loop extends around the longitudinal axis of the applicator over a range of between 20° and 350°.

23. The applicator according to claim 1, wherein at least one of the loops has a generally helical shape.

24. The applicator according to claim 1, wherein a direction of a larger dimension of at least one of the loops is parallel to the longitudinal axis.

25. The applicator according to claim 1, wherein a direction of a larger dimension of at least one of the loops is inclined relative to the longitudinal axis by an angle of between 5° and 90°.

26. The applicator according to claim 1, comprising a hollow core.

27. The applicator according to claim 1, arranged so that, seen from one end, no space is left free by the projections over the entire circumference of a core of the applicator.

28. The applicator according to claim 1, comprising a core having more than ten holes extending out of the loops.

29. A cosmetic article comprising an applicator according to claim 1.

30. A method of manufacturing by additive synthesis an applicator comprising projections each having a base and arranged in at least two groups of projections, the applicator having a longitudinal axis, the bases of the projections in the same group forming at least one closed loop through which the longitudinal axis of the applicator does not extend comprising the following steps:
obtaining data concerning the applicator; and
additive synthesis of the applicator using the data.

31. An electronic storage medium comprising stored data to implement the method according to claim 30.

32. A method of placing on a telecommunications network a computer file comprising data suitable for use by a computer program for controlling the implementation of the method according to claim 30, in order to download the computer file.
